(19) United States
(12) Patent Application Publication
(10) Pub. No.: US 2018/0149039 A1
(43) Pub. Date: May 31, 2018

(54) COMPONENT AND METHOD FOR MANUFACTURING SAID COMPONENT

(71) Applicant: ALSTOM Technology Ltd, Baden (CH)

(72) Inventors: Kaspar Loeffel, Zurich (CH); Michael Thomas Maurer, Bad Sackingen (DE); Juan Vicente Haro, Wettingen (CH); Hans-Peter Bossmann, Lauchringen (DE)

(21) Appl. No.: 15/006,440

(22) Filed: Jan. 26, 2016

(30) Foreign Application Priority Data
Feb. 19, 2015 (EP) 15155843.4

(51) Int. Cl. F01D 25/00; B33Y 80/00; B28B 1/00; B33Y 10/00; B23K 15/00; B23K 26/342

(52) U.S. Cl. CPC F01D 25/005; B33Y 80/00; B28B 1/001; B33Y 10/00; B23K 15/0086; F05D 2300/50212; F05D 2220/32; F05D 2230/233; F05D 2230/234; F05D 2230/30; F05D 2300/5024; B23K 26/342

(57) ABSTRACT

A component is disclosed, the component comprising a first material and a second material, wherein a second member made from the second material is embraced by a first member made from the first material. Further, a method is disclosed for manufacturing said component, the method comprising applying an additive manufacturing process, building up a first member from a first material by the additive manufacturing process, and adding a second member made from a second material during the additive manufacturing process and adding further first material to the first member thus embracing the second member.

### CROSS-REFERENCE TO RELATED APPLICATIONS

This application claims priority to EP Application No. 15155843.4 filed Feb. 19, 2015, the contents of which are hereby incorporated in its entirety.

### TECHNICAL FIELD

The present disclosure relates to a component as described in the preamble of claim 1, and further to a method for manufacturing said component as characterized in the independent method claim.

Said component may in certain embodiments be an engine component, in particular a component of a thermal power generation engine, and more in particular a component of a gas turbine engine. It may be a component intended for use in the hot gas path of a gas turbine engine.

### BACKGROUND

In many technological applications a good heat conductivity of certain components used may be required. This may be on the one hand for heat exchangers, but it may on the other hand also be the case for cooled engine components. If for instance a component is highly thermally loaded on one side and cooled on the other side, the cooling will become the more efficient the higher the thermal conductivity of the component is. Furthermore, if hot spots are present on the thermally loaded side, such as may for instance occur if a hot gas jet impinges on the hot gas side of a component, the temperature distribution in the component will be more evened out if the thermal conductivity of the component is high. Also, if the temperature distribution on the coolant side of the component is more evenly distributed, the coolant will be more efficiently used.

However, materials having a high thermal conductivity, such as for instance copper, may lack structural strength and resistance to operation under harsh operation conditions, in particular at elevated temperatures.

### SUMMARY

It is an object of the present disclosure to provide a component having both structural strength at high temperatures and high thermal conductivity. It is a further object of the present disclosure to provide a method for manufacturing said component.

This, besides other beneficial effects which may become apparent to the skilled person in view of the disclosure and explanations below, is achieved by means of the component as disclosed in claim 1 and by the method as claimed in the independent method claim.

Accordingly, a component is disclosed, the component comprising a first material and a second material, wherein a second member made from the second material is embraced by a first member made from the first material. That is to say, the second member made from the second material is held inside the first member made from the first material in a form locked manner. Thus, no welding or other bonding step between the two members made from different materials is required. This allows for instance the use of materials which may not or only very expensively and/or unreliably be bonded to each other and/or may be incompatible for welding, also taking into consideration a possible operation at elevated temperatures. It allows for example to combine metallic and non-metallic materials, for instance one of the members may be made from a metallic material and the other member may be made from a ceramic material. In certain embodiments, the first material may be a metallic material and the second material may be a metallic or ceramic material. The first material may in certain embodiments be a high temperature alloy, such as for instance a nickel base alloy. The second material may for instance, but not limited to, be copper, which would lack the required structural strength, in particular at elevated temperatures. However, as the mechanical performance of the component is provided by the first material, the mechanical properties of the second material are of minor relevance, if any at all.

In one aspect of the present disclosure the second member is fully enclosed by the first member. This may allow the use of a second member made from a material which would even liquefy at operational temperatures. In other embodiments, the second member may extend to a surface of the component. The second member may for instance extend to the coolant side of a hot gas path element of a gas turbine, which would enhance heat conduction from the component to the coolant side and consequently to the coolant. As noted and implied above, it might be found beneficial if the second material is chosen to have a higher thermal conductivity than the first component. In another aspect of the disclosure the second material may be chosen to have a higher thermal expansion coefficient than the first material. This would serve to effect an additional tight fit of the second member within the first member at elevated operational temperatures.

In a further aspect, a component according to the present disclosure may be characterized in that the first member is seamless, that is, a method for producing the component does not involve assembling the first member embracing the second member in joining two or more distinct pieces. The first member may be said to be monolithic or one-piece. This may be achieved in manufacturing the first member by an additive manufacturing process, as is lined out in more detail below. Said process may be one of, but not restricted to, a selective laser melting process and a selective electron beam melting process.

In still further exemplary embodiments of the component according to the present disclosure, the second member comprises at least one even surface and in particular has one of a constant or decreasing cross sectional dimension starting from at least one even surface. This may serve to facilitate manufacturing the component when applying certain manufacturing processes.

Further, a method is disclosed for manufacturing a component of the kind described above. The method comprises applying an additive manufacturing process and building up a first member from a first material by the additive manufacturing process. A second member made from a second material is added during the additive manufacturing process. Further first material is added to the first member by the additive manufacturing process after the second member has been provided, in particular covering the second member, thus embracing the second member.

Producing the first member may comprise disposing a powder of the first material, melting the powder at selected locations, and re-solidifying the resulting melt to form the first member. Such manufacturing processes, as for instance selective laser melting or selective electron beam melting, are generally carried out bottom to top, in a vertical direction.

More particularly, the method may comprise producing a first fragment of the first member, placing the second member, and subsequently adding further first material and covering the second member with first material such as to produce the first member to embrace the second member. Said may in more particular modes of carrying out the method comprise producing the first member fragment with a cavity, said cavity being accessible from outside the first member fragment, and said cavity in particular being shaped as a complementary or counterpart shape to the second member, and further comprising inserting the second member into said cavity. That is to say, in a first step producing the first member by means of the additive method starts and is carried out to a certain point. After that, the second member is put onto and/or inserted into the fragment of the first member which has so far been produced. In a subsequent step, production of the first member is continued, adding further first material embracing the second member. In certain embodiments, the first step of producing the first fragment of the first member comprises building up the first member such as to form a cavity which is shaped as a counterpart shape to the second member, and in which the second member is subsequently received to be flush with the first member. In case the buildup direction is bottom to top, a top end of the second member when placed in said cavity is flush with a top end of the first member first fragment. This might be found beneficial in subsequently recoating the component in continuing the additive manufacturing of the first member, which comprises covering the second member, and in particular covering the second member with a first material metal powder, which is subsequently molten and re-solidified.

The method may comprise selecting the second member such as to comprise at least one even surface, wherein a cross sectional dimension of the second member is constant or decreases starting from at least one even surface, and in particular placing the second member with said even surface on top. The second member may then be conveniently placed on an already produced fragment of the first member with the even surface. Due to the shape of the second member no undercuts will be present for following steps of adding first material. Likewise, the second member may be conveniently placed in a counterpart cavity manufactured in the first member first fragment, while it may be arranged to provide an even surface together with the first member fragment for a subsequent manufacturing step of adding first material.

Adding the second member may comprise placing the second member by means of a robot arm. This might be found useful and beneficial if the process is carried out in a closed process chamber, at controlled conditions, and/or under a shielding gas atmosphere.

It will be appreciated that the various modes of carrying out the teaching of the present disclosure disclosed above may be readily combined with each other.

Further embodiments and benefits of the teaching given above and/or claimed may become readily apparent to the skilled person.

### BRIEF DESCRIPTION OF THE DRAWINGS

The subject matter of the present disclosure is now to be explained in more detail by means of exemplary embodiments shown in the accompanying drawings. The figures show

FIG. 1a is a prior art component;

FIG. 1b is a component according to the present disclosure;

FIG. 2a is a mode of manufacturing a component according to the present disclosure;

FIG. 2b is a mode of manufacturing a component according to the present disclosure;

FIG. 3 is a plan view of an intermediate state of the manufacturing process;

FIG. 4 is a further exemplary embodiment of a component according to the present disclosure; and

FIG. 5 is still a further exemplary embodiment of a component according to the present disclosure.

It is understood that the drawings are highly schematic, and details not required for the technical explanations may have been omitted for the ease of understanding and depiction. It is further understood that the drawings show only selected, illustrative embodiments by way of example, and numerous embodiments not shown may still be well within the scope of the herein claimed subject matter.

### DETAILED DESCRIPTION

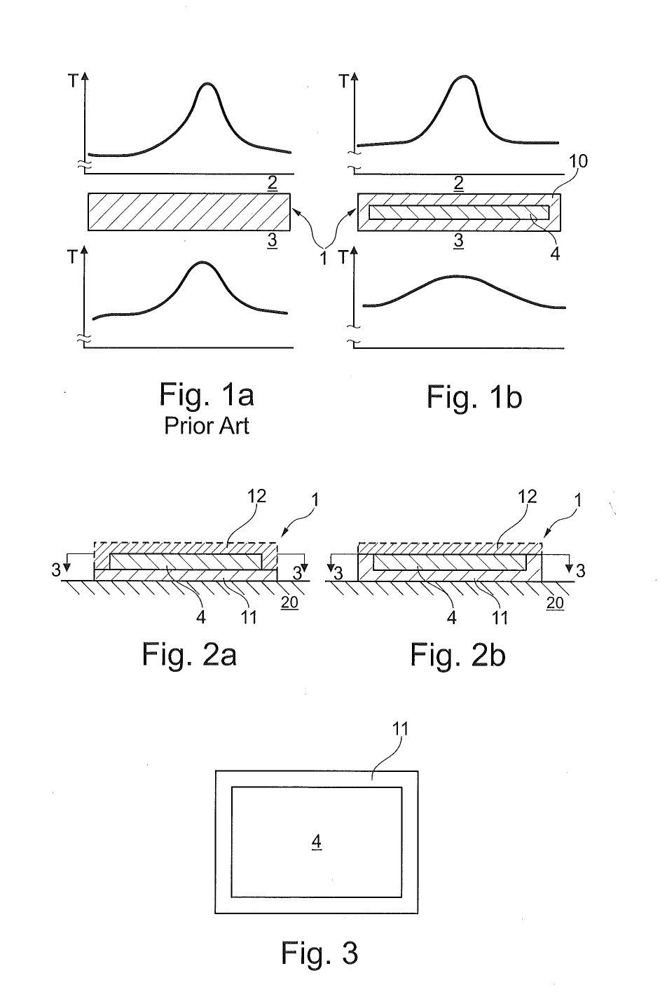

FIGS. 1a and 1b each depict exemplary temperature distributions on the hot gas side and on the coolant side of a component according to the prior art and according to the present disclosure. In both, FIG. 1a) and FIG. 1b), a component 1 is shown which might be used in a hot gas path of a gas turbine engine. The component may in particular be made from a high temperature alloy, such as for instance a nickel base alloy. Component 1 comprises a hot gas side 2 which is intended to face a hot gas flow, and a coolant side 3, which is intended to face a coolant flow. Moreover, exemplary temperature distributions on the surfaces of hot gas side 2 and coolant side 3 are shown. The temperature T distribution on the hot gas side may be dominated by a hot spot, as indicated by the peak in the temperature distribution on the hot gas side. As is seen in the lower part of FIG. 1a), the temperature distribution only marginally evens out over the small distance from the hot gas side 2 to the coolant side 3 in the case of a component homogeneously consisting of one material only. FIG. 1b) depicts a component 1 according to the present disclosure. Component 1 comprises a first member 10 which is made from the same alloy as the prior art component shown in FIG. 1a). The first member 10 embraces a second member 4 made from a second material. The second member 4 being embraced by the first member 10 means, that the first member 10 form-locks the second member 4. As member 4 is held in place within member 10 by form-locking, no bonding connection between first member 10 and second member 4 is required. This means, that the second material of which second member 4 consists needs not to be compatible with the first material of which member 10 consists e.g. for welding. Also, no bonding agent which might be subject to fail at elevated temperatures needs to be applied for connecting the two members 4 and 10. Moreover, the structural strength of component 1, and in particular the structural strength of the component at elevated temperatures, may completely be provided by the first member 10. Summarizing, a great freedom of choice for the material used for second member 4 is provided. In particular, first member 10 may completely enclose second member 4, such that any external surface of component 1 is provided by first member 10, which in turn means, that only first member 10 consisting of the first material is in contact with the environment, which might be hot and/or aggressive fluids. Being completely enclosed by the first member means that the material used for second member 4 needs not to fulfill any requirements as to the durability of the second member under the conditions under which component 1 is used during operation. This further increases the freedom of choice for the material used for second member 4. Second member 4 may consist for instance of a material having a high thermal conductivity, that is in particular having a higher thermal conductivity than the first material. Such a second material may for instance be copper; also a non-metallic, e.g. ceramic, material might be chosen, or, if the second member 4 is completely enclosed by the first member 10, even a material might be chosen which would liquefy during operation of component 1 in the hot gas path of an engine. As a result of applying a plate- or layer-shaped second member 4 being embraced in a first member 10 to form a component 1, wherein second member 4 is made from a material having a higher heat conduction coefficient than the material from which the first member 10 is made, the heat conducted through component 1 from the hot gas side 2 to the coolant side 3 will be laterally distributed in case the component 1 is exposed to an uneven temperature distribution on its hot gas side. The temperature distribution on the coolant side, shown in the lower part of FIG. 1b) thus evens out, with the temperature peak being lowered and the temperature of lateral regions being elevated as compared to the case shown in FIG. 1a). The thermal loading of component 1 is thus more evenly distributed over the component, and moreover a coolant flow flowing over the coolant side 3 is more efficiently used. It should be noted that, dependent on the heat transfer characteristics between the hot gas flow and the hot gas side 2 of component 1, even the temperature distribution of the component on the hot gas side 2 might be less uneven due to the distribution of heat in second member 4.

In the following, a method for manufacturing a component according to the present disclosure is illustrated. In order to manufacture the component such that the second member is embraced or in particular enclosed by the first member, the first member needs to be manufactured in a way in which it is able to encase the second member during the manufacturing process. As the second member is embraced or enclosed by the first member 10, there is no access to insert the second member into the first member once the production of the first member is finished. One way of doing that might be to assemble the first member 10 from individual pieces. These might for instance be welded together. However, the process of assembling the component in that way might turn out expensive, and moreover the material used for the first member 10, such as for instance high temperature alloys, might be difficult to weld and/or to machine. Thus, it is proposed to manufacture the component 1 in applying an additive manufacturing process, such as for instance selective laser melting or selective electron beam melting.

FIG. 2 depicts exemplary modes (FIG. 2a and FIG. 2b) of manufacturing a component 1 in applying an additive manufacturing process to build the first member. Firstly, a first fragment 11 of the first member is manufactured on a build platform 20 by an additive manufacturing method. Examples of additive manufacturing methods are per se known in the art and thus do not require detailed explanations. The method may for instance comprise disposing a layer of metal powder on the build platform, selectively melting and re-solidifying the powder at selective locations, recoating the layer of solid material thus produced with a new layer of metal powder, and again melting and re-solidifying the material which has been disposed on the preceding layer of solidified material. After having repeated that disposing, melting and re-solidifying process a multitude of times, a first fragment 11 of the first member has been produced. In the embodiment shown in FIG. 2a), a flat fragment 11 has been produced, while in the embodiment shown in FIG. 2b) a tub-shaped fragment 11 has been produced, which comprises a cavity. In the next step, a second member 4 consisting of a second material, being different from the material which is used to build the first member, is placed onto the fragment 11 in FIG. 2a), or into the cavity formed in tub-shaped fragment 11 in FIG. 2b). To this extent the cavity in fragment 11 may have been manufactured to exhibit a complementary shape to second member 4. As the additive manufacturing process might take place in a closed processing chamber, placing the second member 4 may in particular be done by a robot arm. In the embodiment shown in FIG. 2b), the first fragment may be manufactured such, and the thickness of the second member 4 may be chosen such, that the second member 4 and the fragment 11 are flush with each other on their top ends. The cavity and the second member 4 might have shapes complementary to each other. This might facilitate a subsequent recoating step, that is, placing a layer of metal powder immediately onto the second member 4 and the fragment 11. To this extent, the second member 4 in the embodiment provided here has an even surface, in particular an even top surface. In consecutive steps, the additive production of the first member is continued, in placing consecutive layers of metal powder, which is the same material as used for manufacturing the fragment 11, besides the second member 4, or on top of it, respectively, and melting and re-solidifying the material in each layer. The resulting structure produced by the additive manufacturing process after the second member 4 has been placed is indicated at 12. FIG. 3 depicts a plan view onto the build platform after the second member 4 has been placed. The respective sections are marked accordingly in FIGS. 2a) and 2b). As is seen, after the production is finished, the second member 4 will be completely enclosed by the first member. In applying an additive manufacturing process to build the first member of component 1, said first member can be built in a seamless manner, that is, as a monolithic, one-piece member embracing the second member.

It should be noted, that due to the shrinking of material of the first member while it re-solidifies during the manufacturing process, a tight fit of the second member within the first member may be achieved. Moreover, if component 1 is intended for operation at elevated temperatures, and the thermal expansion coefficient of the second material of which the second member consists is higher than the thermal expansion coefficient of the first material of which the embracing first member consists, said tight fit will be fostered during operation. Eventual rattling of the second member inside the first member may thus be avoided.

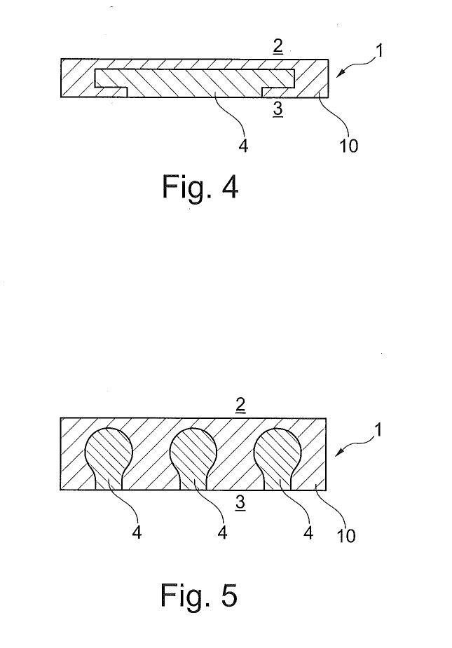

FIGS. 4 and 5 show further embodiments of components 1 according to the present disclosure. In both cases, the second member 4 extends to the surface of component 1. Second member 4 is shaped such as to be still embraced by the first member 10, while not being completely enclosed. In particular, if a second member 4 being made from a material having a higher thermal conductivity than the material from which a first member 10 is made extends to a coolant surface or side 3 of the component 1, the conduction of heat towards the cooling side may be enhanced. In the embodiment of FIG. 4, the second member 4 is roughly plate- or layer-shaped and extends to the coolant site 3. In the embodiment of FIG. 5 a multitude of pear-shaped second members are arranged and extend to the coolant side 3 of component 1.

While the subject matter of the disclosure has been explained by means of exemplary embodiments, it is understood that these are in no way intended to limit the scope of the claimed invention. It will be appreciated that the claims cover embodiments not explicitly shown or disclosed herein, and embodiments deviating from those disclosed in the exemplary modes of carrying out the teaching of the present disclosure will still be covered by the claims.

1. A component, the component comprising a first material and a second material, characterized in that a second member made from the second material is embraced by a first member made from the first material.

2. The component according to claim 1, wherein the second member is fully enclosed by the first member.

3. The component according to claim 1, wherein the second member extends to a surface of the component.

4. The component according to claim 1, wherein the second material is chosen to have a higher thermal conductivity than the first material.

5. The component according to claim 1, wherein the second material is chosen to have a higher thermal expansion coefficient than the first material.

6. The component according to claim 1, wherein the first member is seamless.

7. The component according to claim 1, wherein the second member comprises at least one even surface and in particular has one of a constant or decreasing cross sectional dimension starting from at least one even surface.

8. The component according to claim 1, wherein the first member is producible by an additive manufacturing method.

9. A method for manufacturing a component according to claim 1, the method comprising applying an additive manufacturing process, building up a first member from a first material by the additive manufacturing process, adding a second member made from a second material during the additive manufacturing process and adding further first material to the first member thus embracing the second member.

10. The method according to claim 9, further comprising producing a first fragment of the first member, placing the second member, and subsequently adding further first material and covering the second member with first material such as to produce the first member to embrace the second member.

11. The method according to claim 10, further comprising producing the first fragment of the first member comprises producing the first member with a cavity, said cavity being accessible from outside the first fragment, and said cavity in particular being shaped as a complementary shape to the second member, further comprising inserting the second member into said cavity.

12. The method according to any of the preceding method claims, characterized in that adding the second member comprises placing the second member by means of a robot arm.

13. The method according to claim 9, wherein producing the first member comprises disposing a powder of the first material, melting the powder at selected locations, and re-solidifying the resulting melt to form the first member.

14. The method according to claim 9, further comprising selecting the second member such as to comprise at least one even surface wherein a cross sectional dimension of the second member is constant or decreases starting from at least one even surface, and in particular placing the second member with said even surface on top.

15. The method according to claim 9, wherein manufacturing the first member comprises one of a selective laser melting process and a selective electron beam melting process.
